(19) United States
(12) Patent Application Publication
(10) Pub. No.: US 2011/0124531 A1
(43) Pub. Date: May 26, 2011

(54) Composition of Specifically Formulated Phosphate Salts, Used for Increasing Density of Completion Fluids, and as a Hi-Temperature and Easy to Use Completion Fluids in the Oil and Gas Industry

(75) Inventor: Hendra Budiman, Jakarta Utara (ID)

(73) Assignee: PT. GREENTECH INDONESIA, Tangerang (ID)

(21) Appl. No.: 13/020,676

(22) Filed: Feb. 3, 2011

Related U.S. Application Data
(63) Continuation-in-part of application No. PCT/ID2009/000002, filed on Oct. 28, 2009.

(30) Foreign Application Priority Data
Aug. 29, 2008 (ID) P00200800576

(51) Int. Cl. C09K 8/05

(52) U.S. Cl. 507/142

(57) ABSTRACT

Improved compounds and methods for applications in the oil and gas industry are obtained by the disclosed compositions of phosphate salts. These salts have characteristics beneficial to the oil and gas industry for completion fluids, killing fluids, work-over fluids, drilling fluids and packer fluids. These features include high density (up to SG 2.50), low corrosiveness, stability, not subject to disturbance from formation reaction, not prone to precipitate, environmentally sound, capable of buffering pH, and the disclosed formulation is easy to mix in the field with the capability of increasing the density of existing completion fluids used.

### CROSS-REFERENCE TO RELATED APPLICATIONS

This Application is a Continuation-In-Part claiming priority from PCT Application Number PCT/ID2009/000002, filed Oct. 28, 2009, and claiming priority from Indonesian Patent Application P00200800576, filed Aug. 29, 2008. Both of these applications are incorporated herein by reference for all purposes.

### BACKGROUND OF THE INVENTION

In the oil and gas industry, people have been using certain salt fluids as a killing fluid (fluids used to kill the pressure of formation in the exploration well), completion fluid (fluids used to complete the drill in job in the exploration well), and work-over fluid (fluids used to maintain and service the producing well). The type of salt is adjusted according to the required density. For lower density, Chloride based salt will be used, for a higher density requirement, Bromide based salts would be used. For example if the required density of formation is only 1.20, then NaCl will be used. If the required density is 1.40, then CaCl₂ salt would be used. For density requirements up to 1.50, NaBr, or up to 1.80, CaBr₂ would be used.

Beyond the density requirement, a good killing fluid, completion fluid, or work-over fluid must not contain any calcium or barite in order to avoid precipitation or calcium plugging in the down hole formation. Those fluids must also be able to perform at a very high temperature (up to 400-450 degree Fahrenheit), and have a certain value of viscosity that would help a sweeping capability for debris and dirt in the formation.

Another important aspect of a good killing fluid, completion fluid, or work-over fluid is a low corrosion rate. The higher the density requirement, the higher the formation temperature, the higher the corrosion rate. Unfortunately, a high density completion fluid that contains a Bromide salt (especially ZnBr₂), has a very high corrosion rate due to its low pH (pH=0-1). Combined with high temperature (up to 450 degrees Fahrenheit), the corrosion rate will be increased significantly and will surely be destructive to all steel drilling pipes and casing.

Specially formulated phosphate salts have some favorable characteristics as a good killing fluid, completion fluid, and work-over fluid in oil and gas industry. These salts have densities of up to 2.50, perform very well at extremely high formation temperatures (up to 450 degrees Fahrenheit), have a favorable pH between 9-10.5, have a viscosity favorable to oil and gas exploration, and have low corrosion rates. With the above characteristics, these phosphate salts can be used to substitute and replace the salts used in conventional completion fluids, such as NaCl, KCl, NaBr, KBr, and CaBr₂. Since these phosphate salts are comprised of ingredients used in plant fertilizers, these particular phosphate salts would be safe for use near crops.

In this respect, these salts outperform bromide- and chloride-based completion fluids in terms of environmental safety.

Despite the promising advantages of specially formulated phosphate brines, these prior art salts have several weaknesses. One of the issues is difficulty in mixing and producing this salt. In order to get a high density, especially above 1.80, the operator must maintain an extremely hot mixing temperature of up to 130 degree Celsius, as described in Indonesian Patent ID 0 020 318. This hot mixing temperature would surely be unfavorable to perform in the field. The only possibility would be to mix the phosphate salts in a factory equipped with a reaction chamber and equipment prepared for the reactions and having a cooling facility in order to speed up the overall process. The end product would then be delivered in a liquid form. With this preformulated liquid, it would be difficult for an operator to increase the density in the field should it be required. It would be impossible to get the maximum density of the completion fluid with an addition of new liquid completion fluids. Inventions in this patent would solve the above weaknesses. The compositions and raw materials of these phosphate salts have been improved to a new formula that can solve the above weaknesses while maintaining the benefits of these particular phosphate salts.

In addition, in order to increase the density from 1.861 to 2.50, we could mix the phosphate salts with hi-concentration phosphoric acid, and/or poly-phosphoric acid, and/or metal formate, and/or metal oxide, and/or metal hydroxide.

There are several existing patents related to phosphate salts for oil and gas applications, such as U.S. Pat. No. 4,967,838 that claim application of DKP (K₂HPO₄)+Hexavalent Cromium as corrosion inhibitor. This patent claim for a lower density completion fluids and unfortunately with DKP, pH of salt solution will be around 11 which are too alkaline and that would be more corrosive than salt solution using normal to slightly alkaline pH. U.S. Pat. No. 4,967,838 also claim application of DKP having a maximum density of 14.1 ppg (Specific Gravity=1.69). Our previous Indonesian patent ID 0 020 318 has already optimized the maximum density of proprietary formulated phosphate salts up to 15.4 ppg (Specific Gravity=1.85) by using different formulation, an optimally high mixing temperature and working conditions. Unfortunately all above patents have not overcome weaknesses of phosphate salts as stated above.

### BRIEF SUMMARY OF THE INVENTION

This invention is based on a certain composition of phosphate salts located between Mono-Potassium di-Hydrogen Phosphate (KH₂PO₄) and Di-Potassium Hydrogen Phosphate (K₂HPO₄). The resulted product would have some advantages over individual Mono-Potassium Di-Hydrogen Phosphate or Di-Potassium Hydrogen Phosphate for the oil and gas applications.

Then in order to increase the maximum density of solution from 1.861 to 2.50, we could mix the salts with hi-concentration phosphoric acid (with content of P₂O₅>85%) and/or poly-phosphoric acid, and/or metal formate, and/or metal oxide, and/or metal hydroxide.

Furthermore, this formulation would be able to solve the weaknesses of Phosphate salts currently used for completion and killing job in oil and gas well explorations.

Specifically formulated compositions of phosphate salts are described. The composition will meet the requirements of oil and gas exploration and maintenance of wells. These salts may function as: completion fluids, killing fluids, work-over fluids, packer fluids, in the high density oil and gas well up to density of 2.50 and can be used to replace commonly used fluids such as: NaCl, KCl, CaCl₂, NaBr, KBr, KF, and CaBr₂. This salt composition will also solve its weaknesses such as: capability to mix easily at the field and also capability to increase the density of currently used completion fluids.

### DETAILED DESCRIPTION OF THE INVENTION

Phosphate salt based fluids have been used as an alternative fluids for replacing conventional completion fluids used in oil and gas industry, such as Chloride based (NaCl, KCl, CaCl₂) and Bromides (NaBr, KBr, CaBr₂, ZnBr₂).

Phosphate-based fluids have several advantages over chloride and bromide based completion fluids. Phosphate as one type of fertiliser used in commercial plantations, is more environmentally friendly than commonly used bromides and chlorides. For high density application, phosphate based completion fluids can achieve a density up to 2.50, higher than those of ZnBr2, and phosphate based fluids have much lower corrosion rates than bromides (ZnBr₂), while chloride based completion fluids can achieve a maximum density only at 1.40 (CaCl₂). On the other hand, Phosphate based completion fluids have several disadvantages. It is not easy to make or mix phosphate based completion fluids in the field because of its requirement of high mixing temperature. In order to make a stabile density of 1.80, it is required to maintain mixing temperature up to 130 deg Celsius (as stated in our Indonesian Patent ID 0 020 318). Otherwise, the phosphate salts would precipitate at a density much lower than 1.80. That is the reason so far the phosphate based completion fluids is always pre-mixed in the factory, and always sold as a liquid product, not as a powder, and because it is sold as a liquid product, it is difficult for the field operator to increase the density of product in the field if it should be required.

Herein is described the composition of phosphate salts, specifically formulated for applications in Oil and Gas Industry. This salt has characteristics required by oil and gas industry for a completion fluid and killing fluids such as high in density (up to 2.50), low corrosive, stabile and can withstand disturbance from formation, do not precipitate, has capability to buffer the pH, and also can solve its weaknesses which is easy to mix in the field and has capability to increase the density of existing completion fluids.

Composition of Phosphate salts according to this invention is located between commercially available phosphate salts as follows:
Mono-Potassium Di-Hydrogen Phosphate/KH₂PO₄, and
Di-Potassium Hydrogen Phosphate/K₂HPO₄

Where for the relevant application in oil and gas industry, Mono-Potassium Di-Hydrogen Phosphate/KH₂PO₄, with composition between atomic mass of Potassium (K) to Phosphorus (P) of 1.3:1, has capabilities as follows:
Maximum Specific Gravity/SG:1.15
pH at crystallization point at:4.5-4.8

Where for the relevant application in oil and gas industry, Di-Potassium Hydrogen Phosphate/K₂HPO₄, with composition between atomic mass of Potassium (K) to Phosphorus (P) of 2.516:1, has capabilities as follows:
Maximum Specific Gravity/SG:1.73
pH at crystallization point at:10.9-11.2

The phosphate salts produced according to this invention would outperform both of the above commercially available phosphate salts for the following characteristics:
Maximum Specific Gravity/SG:1.86
pH between 9.5-10.2

In addition to those advantages, the phosphate salt according to this invention would overcome the requirement of high mixing temperature as stated in our patent. The minimum mixing temperature for optimum reaction is only about 38-40 degree Celsius which is much lower than the mixing temperature of up to 130 degree Celsius, according to our patent ID 0 020 318. With this low mixing temperature requirement, now it is safe to mix and produce this salt directly in the field tank with a minimum supervision. Furthermore with a minimum requirement of water as a diluter or without requirement of water for the reaction, now we can use this salts to increase the concentration and specific gravity of killing fluids and completion fluids that have been used in the field.

Furthermore, in order to increase the maximum density of solution of this phosphate salts from 1.861-2.50, we could mix the phosphate salts with hi-concentration phosphoric acids, and/or poly-phosphoric acid and/or metal formate, and/or metal oxide, and/or metal hydroxide. Which metal according to this definition is metal ion located in column 1A, in the chemical period of table.

Examples of Formulation:

$$1. {H}_{2} O 30 gr$$

$$\frac{Di Potassium Hydrogen Phosphate 70 gr}{SG \text{:} 1.73 , pH 10.93 , Crystallization occured} + \\ 2. {H}_{2} O 30 gr$$

$$\frac{Di \text{-} Potassium Hydrogen Phosphate 70 gr {H}_{3} {PO}_{4} 3.2 gr}{SG maximum 1.80 , pH 9.9 , Crystallization occured} + \\ 3. {H}_{2} O 30 gr$$

$$\frac{Di \text{-} Potassium Hydrogen Phosphate 70 gr {H}_{3} {PO}_{4} 4 gr}{SG 1.813 , pH 10.93 , no Crystal} + ( temperature 50 deg Celcius )$$

$$4. Reaction of \text{:} {H}_{2} O + KOH + Mono \text{-} Potassium Di \text{-} Hydrogen phosphate$$

Begining SG: 1.00
Begining pH: 7.72
Quantity of water = 100 ml

| | Total | | | | |
|---|---|---|---|---|---|
| Step | (gr) | SG | pH | Temp (deg. C.) | Volume |
| 1 | 17.5 | 1.178 | 7.95 | 38 | — |
| 2 | 35 | 1.263 | 8.18 | 42 | — |
| 3 | 52.5 | 1.337 | 8.38 | 47 | — |
| 4 | 70 | 1.403 | 8.51 | 49 | — |
| 5 | 87.5 | 1.466 | 8.64 | 47 | — |
| 6 | 105 | 1.5 | 8.8 | 47 | — |
| 7 | 122.5 | 1.55 | 8.92 | 46 | — |
| 8 | 140 | 1.579 | 9.07 | 46 | — |
| 9 | 157.5 | 1.625 | 9.2 | 45 | — |
| 10 | 175 | 1.655 | 9.32 | 45 | — |
| 11 | 192.5 | 1.683 | 9.39 | 45 | — |
| 12 | 210 | 1.69 | 9.51 | 44 | — |
| 13 | 227.5 | 1.72 | 9.61 | 44 | — |
| 14 | 245 | 1.738 | 9.68 | 44 | — |
| 15 | 262.5 | 1.761 | 9.77 | 44 | — |
| 16 | 280 | 1.79 | 9.85 | 44 | — |
| 17 | 297.5 | 1.805 | 9.91 | 44 | 220 ml |

While a number of exemplary aspects and embodiments have been discussed above, those of skill in the art will recognize certain modifications, permutations, additions and sub-combinations therefor. The terminology used herein is for the purpose of description and not of limitation. It is therefore intended that the following appended claims hereinafter introduced are interpreted to include all such modifications, permutations, additions and sub-combinations as are within their true spirit and scope.

The terms and expressions which have been employed are used as terms of description and not of limitation, and there is no intention in the use of such terms and expressions of excluding any equivalents of the features described or portions thereof, but it is recognised that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

In general the terms and phrases used herein have their art-recognized meaning, which can be found by reference to standard texts, journal references and contexts known to those skilled in the art. Any definitions included are provided to clarify their specific use in the context of the invention.

1. A composition of specifically formulated phosphate salt for increasing the density/specific gravity of completion fluids, and also as a killing fluids in the oil and gas industry: the salt is located between Mono-Potassium Di-Hydrogen Phosphate, and Di-Potassium Hydrogen Phosphate, which are made based on reaction between:
phosphate salt or salts and KOH;
phosphate salt or salts and H₃PO₄; and
with or without diluter/solvent,
thereby forming the composition of specifically formulated phosphate salt.

2. The composition of specifically formulated phosphate salt, according to claim 1, wherein the ratio between the atomic mass of Potassium(K) to Phosphorus (P) is 1.31-2.50:1.

3. The composition of specifically formulated phosphate salt, according to claim 1, where phosphate salt is used as a base for mixing is/are Di-Potassium Hydrogen Phosphate and/or Mono-Potassium Di-Hydrogen Phosphate.

4. The composition of specifically formulated phosphate salt, according to claim 1, where the diluter/solvent is water.

5. The composition of specifically formulated phosphate salt, according to claim 1, where the working temperature during mixing at a specific temperature between 35-130 degree Celsius, at 1 atmosphere pressure, or at equivalent temperature and atmosphere pressure.

6. The composition of specifically formulated phosphate salt, according to claim 1, forming a solution, wherein the pH of the solution is between 9.0-10.8.

7. The composition of specifically formulated phosphate salt, according to claim 1, where the density (specific gravity/SG) of the solution is between 1.74-1.86.

8. The composition of specifically formulated phosphate salts, according to claim 1, where in order to increase the density (specific gravity/SG) of solution from 1.861-2.50, the composition is mixed with at least one of: hi-concentration phosphoric acid (with concentration of P₂O₅ above 85%), and/or poly-phosphoric acid.

9. The composition of specifically formulated phosphate salts, according to claim 1, where in order to increase the density (specific gravity/SG) of the solution from 1.861-2.50, the composition is mixed with at least three of: hi-concentration phosphoric acid (with concentration of P₂O₅ above 85%), and/or polyphosphoric acid, and/or metal formate, and/or metal oxide, and/or metal hydroxide; wherein the metal of the metal formate, metal oxide, or metal hydroxide is selected from the group defined as metal ion/s located in column 1A of the periodic table of elements.

10. The application of the specifically formulated phosphate salt, according to claim 1 in the oil and gas industry as a work-over fluid, killing fluid, completion fluid, or to increase the specific gravity of completion fluid.

11. The application of the specifically formulated phosphate salt, according to claim 1, in the oil and gas industry as a drilling fluid and packer fluid.
